(19) United States
(12) Patent Application Publication
(10) Pub. No.: US 2016/0070025 A1
(43) Pub. Date: Mar. 10, 2016

(54) WEATHER FORECASTING APPARATUS AND WEATHER FORECASTING METHOD

(71) Applicant: KABUSHIKI KAISHA TOSHIBA, Tokyo (JP)

(72) Inventors: Yuki HANYU, Kawasaki (JP); Tomokazu KAWAHARA, Yokohama (JP); Mitsuru KAKIMOTO, Kawasaki (JP); Hideki KOBAYASHI, Yokohama (JP)

(21) Appl. No.: 14/847,238

(22) Filed: Sep. 8, 2015

(30) Foreign Application Priority Data
Sep. 10, 2014 (JP) 2014-184455

(51) Int. Cl. G01W 1/10

(52) U.S. Cl. CPC G01W 1/10

(57) ABSTRACT

A weather forecasting apparatus includes a first feature quantity calculator, a first error calculator, a first model generator, a first coefficient calculator, and a first predicted value calculator. The first feature quantity calculator calculates a first feature quantity from a sky image. The first error calculator calculates a first error between a predicted numerical value and a measured value of a weather parameter. The first model generator generates a first model indicating a relation between the first feature quantity and the first error. The first coefficient calculator calculates a first coefficient from the first model and the first feature quantity. The first predicted value calculator calculates a first predicted value of the weather parameter at the prediction object day and time based on the first coefficient at the prediction object day and time and the predicted numerical value at the prediction object day and time.

### CROSS REFERENCE TO RELATED APPLICATION(S)

This application is based upon and claims the benefit of priority from the prior Japanese Patent Application No. 2014-184455, filed on Sep. 10, 2014, the entire contents of which are incorporated herein by reference.

### FIELD

Embodiments described herein relate generally to a weather forecasting apparatus and a weather forecasting method.

### BACKGROUND

Conventionally, a numerical value prediction has been used in a field of weather forecast. In the numerical value prediction, a weather parameter is predicted by a numerical value simulation using a high-speed computer. There has been a problem in that a prediction accuracy of the weather parameter which depends on the shape and kind of clouds is low because the shape and kind of clouds are not considered in the numerical value prediction. For example, according to the numerical value prediction, it has been difficult to predict a solar radiation intensity, a composition ratio between direct light and scattering light, and the like which depends on the shape and kind of clouds with high accuracy.

### BRIEF DESCRIPTION OF THE DRAWINGS

FIG. 1 is a block diagram of a function configuration of a weather forecasting apparatus according to a first embodiment;

FIG. 2 is a diagram of exemplary sky images;

FIG. 3 is a table of exemplary predicted numerical values, measured values, and cloud feature quantities;

FIG. 4 is a block diagram of a hardware configuration of the weather forecasting apparatus according to the first embodiment;

FIG. 5 is a flowchart of an operation of the weather forecasting apparatus according to the first embodiment;

FIG. 6 is a graph of exemplary predicted numerical values and measured values;

FIG. 7 is a graph of an exemplary correction model;

FIG. 8 is a graph of exemplary first predicted values;

FIG. 9 is a block diagram of a function configuration of a weather forecasting apparatus according to a second embodiment;

FIG. 10 is a flowchart of an operation of the weather forecasting apparatus according to the second embodiment;

FIG. 11 is a block diagram of a function configuration of a weather forecasting apparatus according to a third embodiment; and

FIG. 12 is a flowchart of an operation of the weather forecasting apparatus according to the third embodiment.

### DETAILED DESCRIPTION

Embodiments will now be explained with reference to the accompanying drawings. The present invention is not limited to the embodiments.

A weather forecasting apparatus according to one embodiment includes a first feature quantity calculator, a first error calculator, a first model generator, a first coefficient calculator, and a first predicted value calculator. The first feature quantity calculator calculates a first feature quantity from a sky image. The first error calculator calculates a first error between a predicted numerical value and a measured value of a weather parameter. The predicted numerical value is a predicted value of the weather parameter by a numerical value simulation. The first model generator generates a first model indicating a relation between the first feature quantity and the first error at a predetermined time after the day and time when the first feature quantity has been calculated. The first coefficient calculator calculates a first coefficient of a prediction object day and time according to the first feature quantity from the first model and the first feature quantity at a predetermined time before the prediction object day and time. The first predicted value calculator calculates a first predicted value of the weather parameter at the prediction object day and time based on the first coefficient at the prediction object day and time and the predicted numerical value at the prediction object day and time.

### First Embodiment

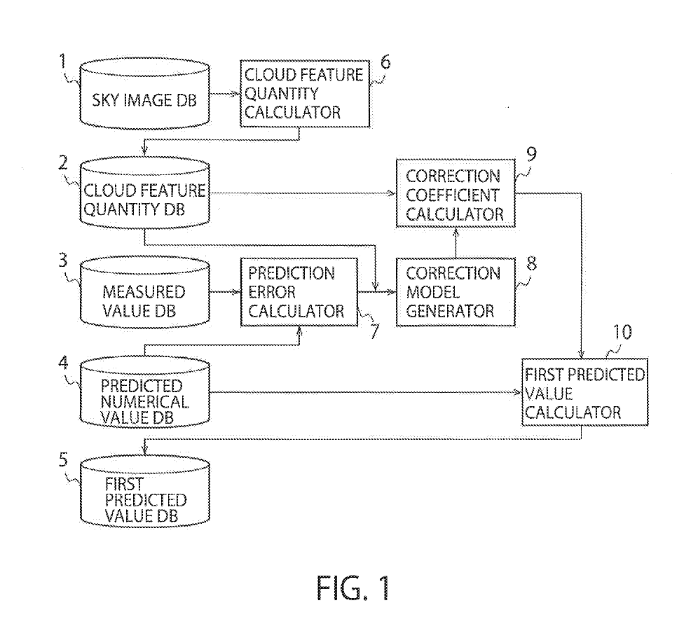

A weather forecasting apparatus according to a first embodiment will be described with reference to FIGS. 1 to 8. The weather forecasting apparatus according to the present embodiment corrects a predicted numerical value of an object parameter at a prediction object day and time based on a cloud feature quantity at a predetermined time before the prediction object day and time. Accordingly, the weather forecasting apparatus calculates a first predicted value of the object parameter at the prediction object day and time.

First, a function configuration of the weather forecasting apparatus according to the first embodiment will be described with reference to FIGS. 1 to 3. FIG. 1 is a block diagram of the function configuration of the weather forecasting apparatus according to the present embodiment. As illustrated in FIG. 1, the weather forecasting apparatus includes a sky image DB 1, a cloud feature quantity DB 2, a measured value DB 3, a predicted numerical value DB 4, a first predicted value DB 5, a cloud feature quantity calculator 6, a prediction error calculator 7, a correction model generator 8, a correction coefficient calculator 9, and a first predicted value calculator 10.

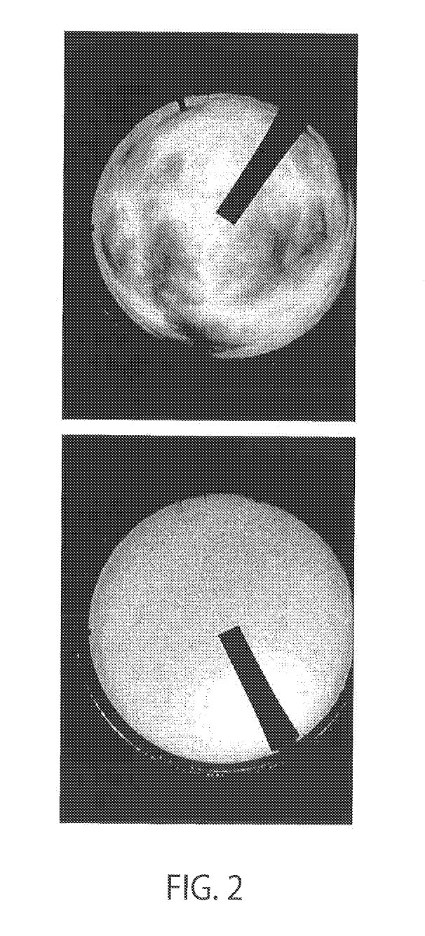

The sky image DB 1 stores a sky image. The sky image is an image of the sky imaged by a camera for weather observation. The camera for weather observation may be installed on the ground and may be mounted on a weather satellite. FIG. 2 is a diagram of exemplary sky images. FIG. 2 is sky images imaged by an omnidirectional camera installed on the ground, and the two sky images are imaged at different day and time from each other. As illustrated in FIG. 2, it can be found that the cloud is substantially uniform in one sky image and a difference between brightness and darkness of the cloud is large in another sky image.

The cloud feature quantity DB 2 stores at least one cloud feature quantity (first feature quantity). The cloud feature quantity is a feature quantity calculated by performing image analysis to the sky image as illustrated in FIG. 2. The cloud feature quantity is, for example, a luminance, a blue component luminance, a blue component ratio, a luminosity distribution, a chroma, a color, the thickness of the cloud, the shape of the cloud, or a particle size of the cloud. However, the cloud feature quantity is not limited to these.

The measured value DB 3 stores measured values of at least one weather parameter including the object parameter. The weather parameter is a parameter indicating a weather condition. The weather parameter is, for example, a temperature, a humidity, a solar radiation intensity, a wind direction, a wind speed, and a precipitation. However, the weather parameter is not limited to these. The object parameter is a weather parameter to be predicted by the weather forecasting apparatus from among the weather parameters, that is, a weather parameter to be used by the weather forecasting apparatus to calculate the first predicted value. The measured value of the weather parameter is a value of the weather parameter directly measured by a sensor or a value of the weather parameter calculated from the value which has been directly measured.

The predicted numerical value DB 4 stores predicted numerical values of at least one weather parameter including the object parameter. The predicted numerical value is a predicted value of the weather parameter calculated by the numerical value simulation. The weather forecasting apparatus obtains the predicted numerical value from a private or public weather forecasting service and stores it in the predicted numerical value DB 4.

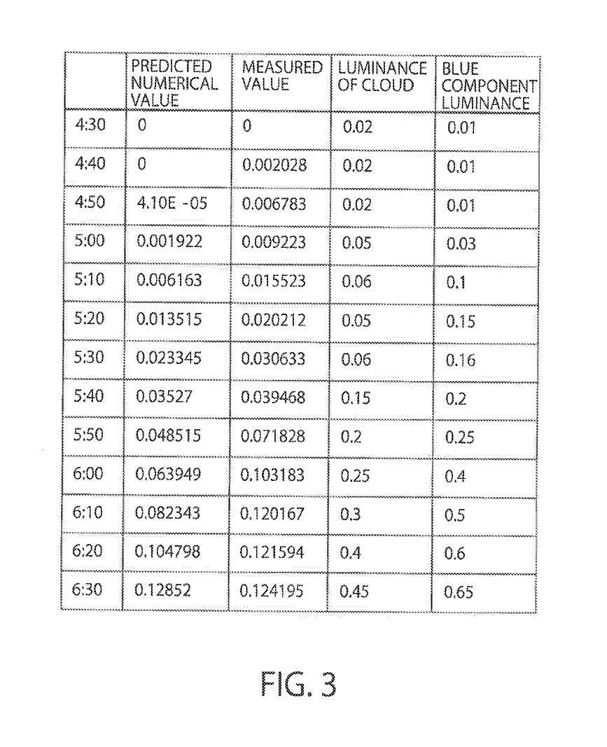

Here, FIG. 3 is a table of exemplary cloud feature quantities, measured values, and predicted numerical values respectively stored in the cloud feature quantity DB 2, the measured value DB 3, and the predicted numerical value DB 4. In FIG. 3, the weather parameter is the solar radiation intensity, and the cloud feature quantity is the luminance and the blue component luminance of the cloud. As illustrated in FIG. 3, the cloud feature quantity DB 2, the measured value DB 3, and the predicted numerical value DB 4 respectively store history data of the cloud feature quantity, the measured value, and the predicted numerical value.

The first predicted value DB 5 stores a first predicted value. The first predicted value is a predicted value of the object parameter calculated by the weather forecasting apparatus according to the present embodiment.

The cloud feature quantity calculator 6 (first feature quantity calculator) obtains the sky image from the sky image DB 1 and calculates the cloud feature quantity by performing the image analysis to the obtained sky image. As a method for performing the image analysis, an existing optional method can be used. The cloud feature quantity calculated by the cloud feature quantity calculator 6 is stored in the cloud feature quantity DB 2.

The prediction error calculator 7 (first error calculator) calculates a prediction error (first error). The prediction error is an error between the predicted numerical value and the measured value of the object parameter. The prediction error calculator 7 obtains the measured value and the predicted numerical value of the same day and time respectively from the measured value DB 3 and the predicted numerical value DB 4 and calculates the prediction error. The prediction error is, for example, a value of the predicted numerical value/the measured value, the predicted numerical value−the measured value, and a value calculated based on these.

The correction model generator 8 (first model generator) generates a correction model (first model). The correction model is a model indicating a relation between the cloud feature quantity at a certain day and time and a prediction error at a predetermined time after the day and time when the cloud feature quantity has been calculated. The day and time when the cloud feature quantity has been calculated is the photographing date and time of the sky image used to calculate the cloud feature quantity. It is assumed that the predetermined time is N hours (N>0) below. For example, in a case of N=3, the correction model indicates a relation between the cloud feature quantity at a certain day and time and the prediction error at three hours after that.

The correction model is generated, for example, by mathematically approximating a correlation between the cloud feature quantity at a certain day and time and the prediction error at N hours after that. A linear approximation, a logarithmic approximation, a power approximation, and the like are used as an approximation method. According to this, a regression formula having the cloud feature quantity as an explanatory variable and the prediction error as an objective variable is generated as the correction model.

The correction coefficient calculator 9 (first coefficient calculator) calculates a correction coefficient (first coefficient). The correction coefficient is the prediction error at the prediction object day and time. The prediction object day and time is the day and time of which the weather forecasting apparatus calculates the first predicted value.

The correction coefficient calculator 9 obtains the correction model from the correction model generator 8 and obtains the cloud feature quantity at N hours before the prediction object day and time from the cloud feature quantity DB 2. When the correction model is the regression formula, the correction coefficient calculator 9 calculates the prediction error at the prediction object day and time, that is, the correction coefficient by substituting the cloud feature quantity at N hours before the prediction object day and time into the correction model.

The first predicted value calculator 10 calculates a first predicted value. The first predicted value calculator 10 obtains the predicted numerical value at the prediction object day and time from the predicted numerical value DB 4 and obtains the correction coefficient at the prediction object day and time from the correction coefficient calculator 9. The first predicted value calculator 10 calculates the first predicted value at the prediction object day and time by correcting the predicted numerical value at the prediction object day and time based on the obtained correction coefficient. The first predicted value calculator 10 corrects the predicted numerical value so that an error between the predicted numerical value and the measured value is reduced. The first predicted value calculated by the first predicted value calculator 10 is stored in the first predicted value DB 5.

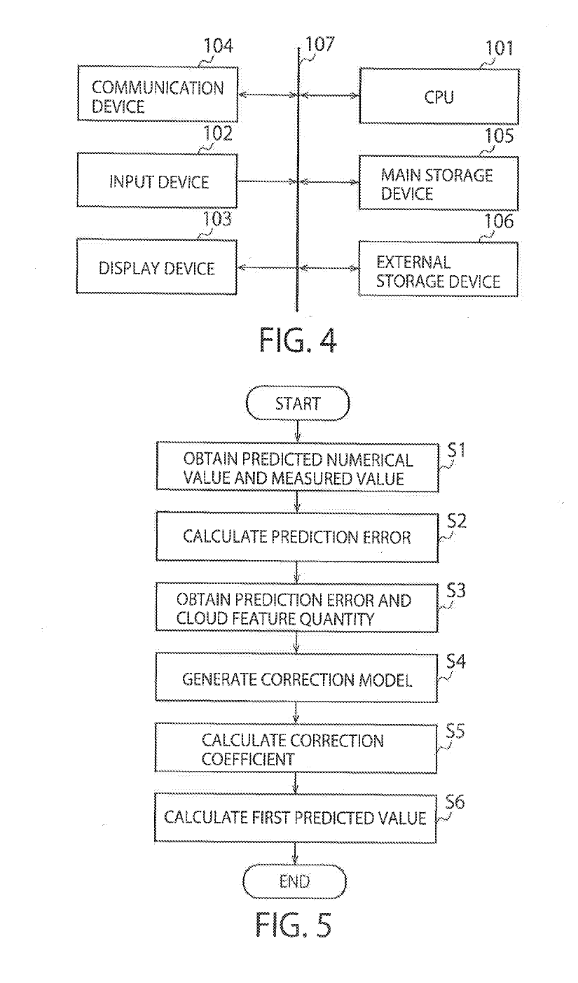

Next, a hardware configuration of the weather forecasting apparatus according to the present embodiment will be described with reference to FIG. 4. The weather forecasting apparatus according to the present embodiment includes a computer device. Here, FIG. 4 is a block diagram of a hardware configuration of the weather forecasting apparatus. As illustrated in FIG. 4, a weather forecasting apparatus 100 includes a CPU 101, an input device 102, a display device 103, a communication device 104, a main storage device 105, and an external storage device 106. These are connected with each other with a bus 107.

The central processing unit (CPU) 101 executes a weather forecasting program in the main storage device 105. The weather forecasting program is a program for realizing each function configuration of the weather forecasting apparatus described above. The CPU 101 executes the weather forecasting program so that each function configuration described above is realized.

The input device 102 is a device to input a data and instruction to the weather forecasting apparatus from outside. The input device 102 may be a device such as a keyboard, a mouse, and a touch panel to which a user directly inputs the data and the like. Also, the input device 102 may be a device such as an USB and a software for allowing an external device to input the data and the like thereto. Information such as the prediction object day and time and the object parameter by the weather forecasting apparatus can be input to the weather forecasting apparatus via the input device 102. Also, the measured value may be obtained by connecting the weather forecasting apparatus to a sensor of the weather parameter via the input device 102.

The display device 103 is a display for displaying a video signal output from the weather forecasting apparatus. The display device 103 is, for example, a liquid crystal display (LCD), a cathode-ray tube (CRT), and a plasma display (PDP). However, the display device 103 is not limited to this. The display device 103 can display the information such as the sky image, the measured value, the predicted numerical value, and the first predicted value stored in each database (DB) and information such as the cloud feature quantity, the prediction error, the correction model, and the correction coefficient generated when the first predicted value is calculated.

The weather forecasting apparatus communicates with the external device via the communication device 104. The weather forecasting apparatus wirelessly/wiredly communicates with the external device by using a predetermined communication method via the communication device 104. The communication device 104 is, for example, a modem and a router. However, the communication device 104 is not limited to this. The information such as the sky image, the measured value, the predicted numerical value, and the first predicted value stored in each database can be input from the external device via the communication device 104.

The main storage device 105 stores the weather forecasting program, necessary data for executing the weather forecasting program, data generated by executing the weather forecasting program, and the like when the weather forecasting program is executed. The weather forecasting program is developed and executed in the main storage device 105. The main storage device 105 is, for example, a RAM, a DRAM, and a SRAM. However, the main storage device 105 is not limited to this. The sky image DB 1, the measured value DB 3, the predicted numerical value DB 4, and the first predicted value DB 5 are constructed in at least one of the main storage device 105 and the external storage device 106. Also, the main storage device 105 may store the OS, the BIOS, and various middlewares of the computer device.

The external storage device 106 stores the weather forecasting program, the necessary data for executing the weather forecasting program, the data generated by executing the weather forecasting program, and the like. These programs and data are read by the main storage device 105 when the weather forecasting program is executed. The external storage device 106 is, for example, a hard disk, an optical disk, a flash memory, and a magnetic tape. However, the external storage device 106 is not limited to this.

The weather forecasting program may be previously installed in the computer device and may be stored in a memory media such as a CD-ROM. Also, the weather forecasting program may be uploaded on the Internet.

Next, an operation of the weather forecasting apparatus according to the present embodiment will be described with reference to FIGS. 5 to 8. FIG. 5 is a flowchart of the operation of the weather forecasting apparatus according to the present embodiment. It is assumed below that the object parameter is the solar radiation intensity. However, the object parameter is not limited to this.

First, in step S1, the prediction error calculator 7 obtains a history data of the measured value of the solar radiation intensity from the measured value DB 3 and obtains a history data of the predicted numerical value of the solar radiation intensity from the predicted numerical value DB 4. A period in which the prediction error calculator 7 obtains the history data of the measured value and the predicted numerical value of the solar radiation intensity may be previously set and may be specified by the user via the input device 102.

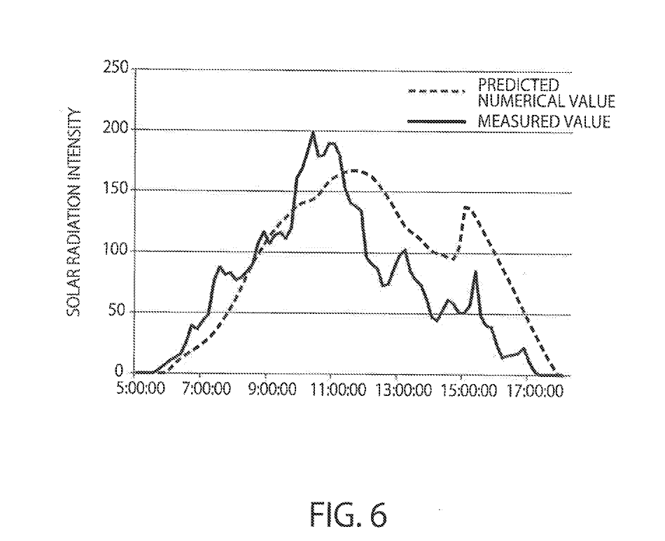

FIG. 6 is a graph of exemplary history data of the measured value and the predicted numerical value of the solar radiation intensity obtained by the prediction error calculator 7. In FIG. 6, a solid line indicates the measured value of the solar radiation intensity between 5:00 and 18:00 on Apr. 10, 2013, and a dashed line indicates the predicted numerical value of the solar radiation intensity between 5:00 and 18:00 on Apr. 10, 2013. As illustrated in FIG. 6, an error between the predicted numerical value and the measured value of the solar radiation intensity occurs.

In step S2, the prediction error calculator 7 calculates the prediction error based on the obtained measured value and predicted numerical value of the solar radiation intensity and generates a history data of the prediction error. It is assumed below that the prediction error is the measured value/the predicted numerical value−1. However, the prediction error is not limited to this.

In step S3, the correction model generator 8 obtains the history data of the prediction error calculated by the prediction error calculator 7 and obtains the history data of the cloud feature quantity from the cloud feature quantity DB 2. Here, the history data of the cloud feature quantity to be obtained by the correction model generator 8 is a history data at N hours before the history data of the prediction error. For example, in a case of N=3, the correction model generator 8 obtains the cloud feature quantity between 7:00 and 12:00 relative to the prediction error between 10:00 and 15:00. The kind of the cloud feature quantity obtained by the correction model generator 8 and the above-mentioned value N may be previously set and may be specified by the user via the input device 102.

The correction model generator 8 generates the correction model in step S4. Here, a linear regression formula which has the prediction error as an objective variable and the cloud feature quantity at N hours before the prediction error as an explanatory variable is generated as the correction model. In this case, the regression formula is expressed as Y=AX+B. Y indicates the prediction error, and X indicates the cloud feature quantity at N hours before the prediction error. A indicates a coefficient (inclination), and B indicates an intercept (prediction error in a case where the cloud feature quantity is zero).

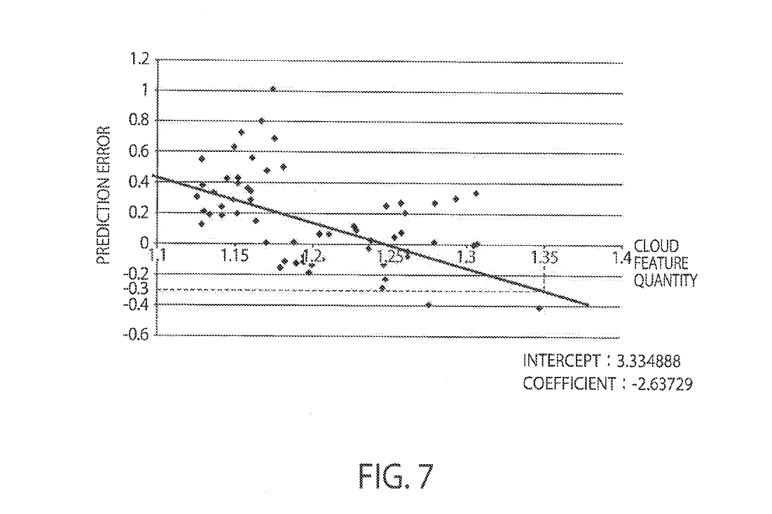

FIG. 7 is a graph of an exemplary regression formula generated in this way. In FIG. 7, the horizontal axis indicates the cloud feature quantity, and the vertical axis indicates the prediction error. Also, in the graph, the prediction error at N hours after the cloud feature quantity is plotted and a regression line according to the regression formula calculated from the plotted points is illustrated. As illustrated in FIG. 7, it can be found that there is a correlation between the cloud feature quantity and the prediction error at N hours after that. This is because a prediction accuracy of the predicted numerical value changes according to the weather condition indicated by the cloud feature quantity.

In step S5, the correction coefficient calculator 9 obtains the correction model generated by the correction model generator 8 and obtains the history data of the cloud feature quantity from the cloud feature quantity DB 2. Here, the history data of the cloud feature quantity to be obtained by the correction coefficient calculator 9 is a history data at N hours before a prediction object period. The prediction object period is a range of the prediction object day and time. For example, when N=3 is satisfied and the prediction object day and time is between 16:00 and 21:00, the correction coefficient calculator 9 obtains the history data of the cloud feature quantity between 13:00 and 18:00.

The correction coefficient calculator 9 calculates the correction coefficient based on the obtained cloud feature quantity and the correction model and generates the history data of the correction coefficient in the prediction object period. When the correction model is the regression formula, the correction coefficient calculator 9 calculates the prediction error at N hours later by substituting the obtained cloud feature quantity into the regression formula. The prediction error is the correction coefficient to correct the predicted numerical value at N hours later, that is, the prediction object day and time. For example, when the correction model in FIG. 7 is referred and the cloud feature quantity at 13:00 is 1.35, the correction coefficient at 16:00 is −0.3.

In step S6, the first predicted value calculator 10 obtains the correction coefficient in the prediction object period calculated by the correction coefficient calculator 9 and obtains the predicted numerical value in the prediction object period from the predicted numerical value DB 4. The first predicted value calculator 10 calculates the first predicted value in the prediction object period based on the obtained correction coefficient and predicted numerical value.

The first predicted value is corrected based on the correction coefficient so that an error between the predicted numerical value and the measured value is reduced. For example, in a case of the correction coefficient (prediction error)=the measured value/the predicted numerical value−1, the first predicted value becomes the predicted numerical value×(1+the correction coefficient). As described above, when the correction coefficient is −0.3, the first predicted value=the predicted numerical value×0.7 is satisfied.

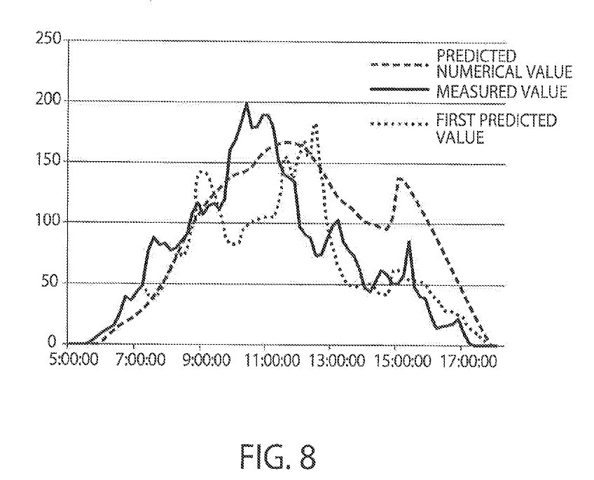

Here, FIG. 8 is a graph of an exemplary history data of the first predicted value in the prediction object period calculated by the first predicted value calculator 10. In FIG. 8, a dotted line indicates the first predicted value of the solar radiation intensity between 5:00 and 18:00 on Apr. 10, 2013. The solid line and the dashed line are similar to those in the graph in FIG. 6. As illustrated in FIG. 8, it can be found that the error between the first predicted value and the measured value becomes smaller than that between the predicted numerical value and the measured value after 12:00 on Apr. 10, 2013.

The first predicted value calculated by the first predicted value calculator 10 is stored in the first predicted value DB 5. Also, the first predicted value may be displayed by the display device 103 and may be output to the external device via the communication device 104.

As described above, the weather forecasting apparatus according to the present embodiment can correct the predicted numerical value based on the cloud feature quantity at N hours before the prediction object day and time. As mentioned above, the cloud feature quantity has the correlation between the predicted numerical value and the prediction error. Therefore, the weather parameter can be predicted with high accuracy by correcting the predicted numerical value by using the cloud feature quantity.

### Second Embodiment

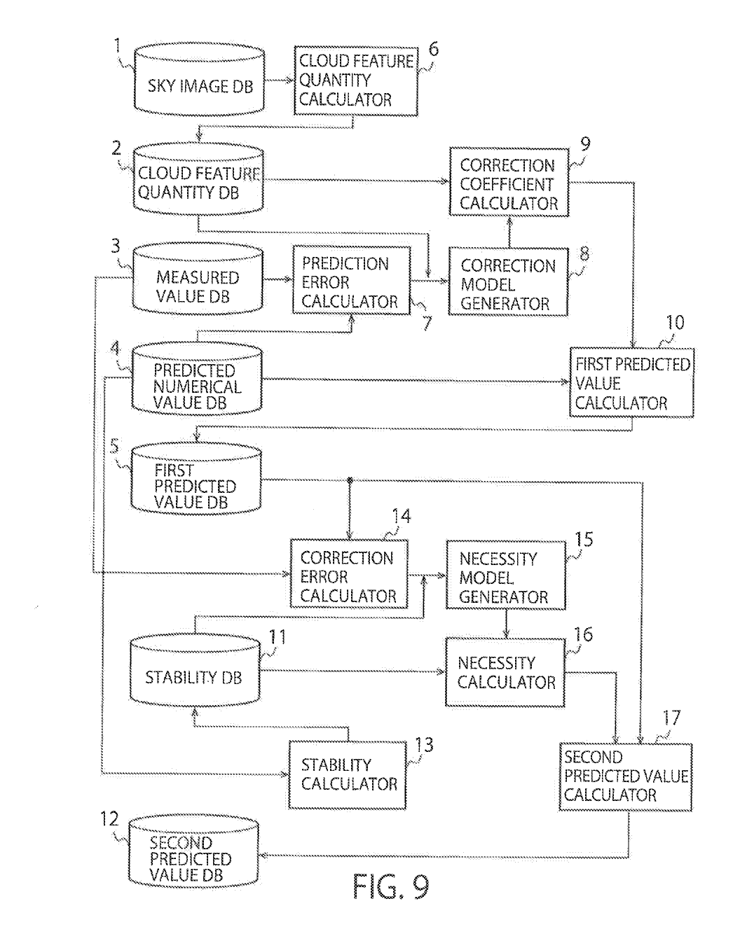

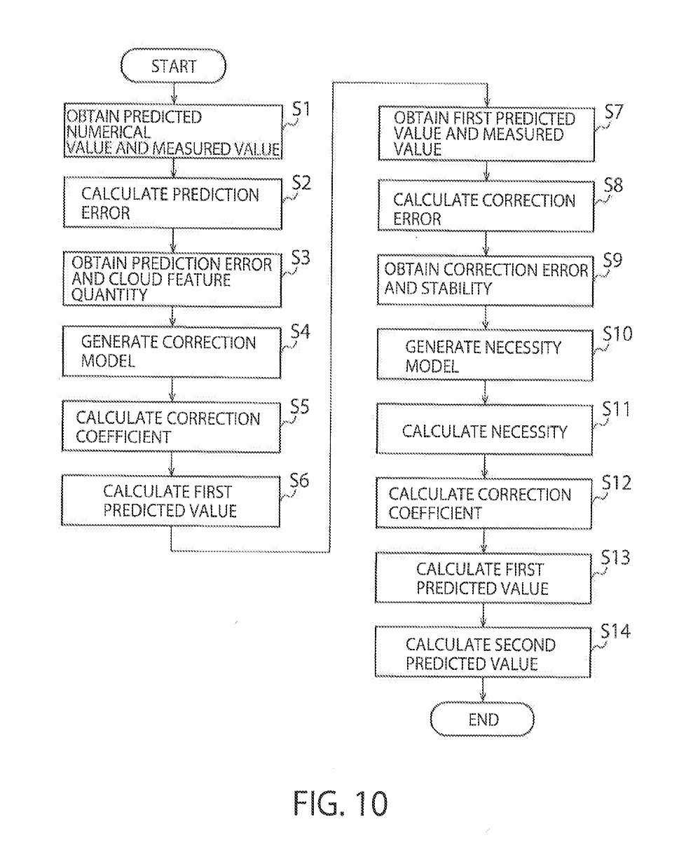

Next, a weather forecasting apparatus according to a second embodiment will be described with reference to FIGS. 9 and 10. The weather forecasting apparatus according to the present embodiment corrects a first predicted value of an object parameter at a prediction object day and time based on a necessity at the prediction object day and time. Accordingly, the weather forecasting apparatus calculates a second predicted value of the object parameter at the prediction object day and time.

First, a function configuration of the weather forecasting apparatus according to the second embodiment will be described with reference to FIG. 9. FIG. 9 is a block diagram of the function configuration of the weather forecasting apparatus according to the present embodiment. As illustrated in FIG. 9, the weather forecasting apparatus further includes a stability DB 11, a second predicted value DB 12, a stability calculator 13, a correction error calculator 14, a necessity model generator 15, a necessity calculator 16, and a second predicted value calculator 17. Other components are similar to those of the first embodiment.

The stability DB 11 stores at least one stability (second feature quantity). The stability is an index indicating a degree of the stability of the atmosphere. The stability is a known index indicating the stability of the atmosphere such as static stability, stratification stability, and convection stability. Also, the stability may be a weather parameter, which can be measured, such as the strength of an ascending current and water transpiration from the ground. In addition, the stability may be an optional variable calculated based on one or a plurality of weather parameters. For example, a rate of change in a predetermined period and inclination of a moving average line of the weather parameter can be used as the stability like above. The magnitudes of the rate of change and the inclination indicate the easiness of the change of the weather. That is, when the rate of the change and the inclination are larger, the weather easily changes and the atmosphere becomes unstable. Also, when the stability is smaller, the weather does not easily change and the atmosphere is stable.

The second predicted value DB 12 stores a second predicted value. The second predicted value is the predicted value of the object parameter calculated by the weather forecasting apparatus according to the present embodiment.

The stability calculator 13 (second feature quantity calculator) calculates at least one stability. In the present embodiment, the stability calculator 13 obtains a predicted numerical value of at least one weather parameter including the object parameter from the predicted numerical value DB 4 and calculates the stability based on the obtained predicted numerical value. The kind of the weather parameter to be obtained by the stability calculator 13 can be optionally selected without being limited to the object parameter. However, it is preferable to be the weather parameter having a large influence on the weather. A solar radiation intensity, a moisture content in the atmosphere, a wind direction, and a wind speed can be exemplified as the weather parameter like this. The stability calculated by the stability calculator 13 is stored in the stability DB 11.

The correction error calculator 14 (second error calculator) calculates a correction error (second error). The correction error is an error between the first predicted value and a measured value of the object parameter. The correction error calculator 14 obtains the measured value and the first predicted value of the same day and time respectively from the measured value DB 3 and a first predicted value DB 5 and calculates the correction error. The correction error is, for example, the first predicted value/the measured value, the first predicted value−the measured value, and a value calculated based on these.

The necessity model generator 15 (second model generator) generates a necessity model (second model). The necessity model indicates a relation between the stability at a certain day and time and a correction error at N hours (N>0) after the day and time when the stability has been calculated. The day and time when the stability has been calculated is the prediction object day and time of the predicted numerical value used to calculate the stability. For example, in a case of N=3, the necessity model indicates a relation between the stability at a certain day and time and the correction error at three hours after that.

The necessity model is generated, for example, by mathematically approximating a correlation between the stability at a certain day and time and the correction error at N hours after that. A linear approximation, a logarithmic approximation, a power approximation, and the like are used as an approximation method. Accordingly, a regression formula having the stability as an explanatory variable and the correction error as an objective variable is generated as the necessity model.

The necessity calculator 16 (second coefficient calculator) calculates a necessity (second coefficient). The necessity is the correction error at the prediction object day and time. Therefore, the necessity indicates whether it is necessary to further correct the first predicted value. For example, when the necessity is zero, the correction error is zero. Therefore, it is not necessary to correct the first predicted value.

The necessity calculator 16 obtains the necessity model from the necessity model generator 15 and obtains the stability at N hours before the prediction object day and time from the stability DB 11. When the necessity model is the regression formula, the necessity calculator 16 calculates the correction error at the prediction object day and time, that is, the necessity by substituting the stability at N hours before the prediction object day and time into the necessity model.

The second predicted value calculator 17 calculates the second predicted value. The second predicted value calculator 17 obtains the first predicted value at the prediction object day and time from the first predicted value DB 5 and obtains the necessity at the prediction object day and time from the necessity calculator 16. The second predicted value calculator 17 calculates the second predicted value at the prediction object day and time by correcting the first predicted value at the prediction object day and time based on the obtained necessity. The second predicted value calculator 17 corrects the first predicted value so that an error between the first predicted value and the measured value is reduced. The second predicted value calculated by the second predicted value calculator 17 is stored in the second predicted value DB 12.

Each function configuration of the weather forecasting apparatus according to the present embodiment is realized by executing the weather forecasting program by the CPU 101.

Next, an operation of the weather forecasting apparatus according to the present embodiment will be described with reference to FIG. 10. FIG. 10 is a flowchart of the operation of the weather forecasting apparatus according to the present embodiment. It is assumed below that the object parameter is the solar radiation intensity. However, the object parameter is not limited to this.

First, the weather forecasting apparatus executes the above-mentioned steps S1 to S6 and generates a history data of the first predicted value. That is, in step S1, the prediction error calculator 7 obtains the history data of the measured value of the solar radiation intensity from the measured value DB 3 and obtains the history data of the predicted numerical value of the solar radiation intensity from the predicted numerical value DB 4. In step S2, the prediction error calculator 7 calculates the prediction error based on the obtained actual measured value and predicted numerical value of the solar radiation intensity and generates the history data of the prediction error. In step S3, the correction model generator 8 obtains the history data of the prediction error calculated by the prediction error calculator 7 and obtains a history data of the cloud feature quantity from the cloud feature quantity DB 2. The correction model generator 8 generates the correction model in step S4.

In step S5, the correction coefficient calculator 9 obtains the correction model generated by the correction model generator 8 and obtains the history data of the cloud feature quantity from the cloud feature quantity DB 2. In the present embodiment, the history data of the cloud feature quantity obtained by the correction coefficient calculator 9 is not limited to the history data at N hours before the prediction object period. The correction coefficient calculator 9 calculates a correction coefficient based on the obtained cloud feature quantity and correction model and generates a history data of the correction coefficient.

In step S6, the first predicted value calculator 10 obtains the correction coefficient calculated by the correction coefficient calculator 9 and obtains the predicted numerical value from the predicted numerical value DB 4. The first predicted value calculator 10 calculates the first predicted value based on the obtained correction coefficient and predicted numerical value and generates a history data of the first predicted value. The history data of the first predicted value is stored in the first predicted value DB 5.

The above-mentioned steps S1 to S6 may be performed when the second predicted value is calculated. Also, steps S1 to S6 may be omitted in a case where the history data of the first predicted value has been previously generated.

Next, in step S7, the correction error calculator 14 obtains the history data of the measured value of the solar radiation intensity from the measured value DB 3 and obtains the history data of the first predicted value of the solar radiation intensity from the first predicted value DB 5. A period in which the correction error calculator 14 obtains the history data of the measured value and first predicted value of the solar radiation intensity may be previously set and may be specified by a user via an input device 102.

In step S8, the correction error calculator 14 calculates the correction error based on the obtained measured value and first predicted value of the solar radiation intensity and generates a history data of the correction error. It is assumed below that the correction error is the measured value/the correction error−1. However, the correction error is not limited to this.

In step S9, the necessity model generator 15 obtains the history data of the correction error calculated by the correction error calculator 14 and obtains a history data of the stability from the stability DB 11. Here, the history data of the stability to be obtained by the necessity model generator 15 is a history data at N hours before the history data of the correction error. For example, in a case of N=3, the necessity model generator 15 obtains the stability between 7:00 and 12:00 relative to the correction error between 10:00 and 15:00. The kind of the stability obtained by the necessity model generator 15 and the above-mentioned value N may be previously set and may be specified by the user via the input device 102.

In step S10, the necessity model generator 15 generates the necessity model. Here, it is assumed that a linear regression formula which has the correction error as an objective variable and the stability at N hours before the correction error as an explanatory variable is generated as the necessity model. In this case, the regression formula is expressed as Y=AX+B. Y indicates the correction error, and X indicates the stability at N hours before the correction error. A indicates a coefficient (inclination), and B indicates an intercept (correction error in a case where the stability is zero).

In step S11, the necessity calculator 16 obtains the necessity model generated by the necessity model generator 15 and obtains the history data of the stability from the stability DB 11. Here, the history data of the stability to be obtained by the necessity calculator 16 is a history data at N hours before the prediction object period. For example, when N=3 is satisfied and the prediction object day and time is between 16:00 and 21:00, the necessity calculator 16 obtains the history data of the stability between 13:00 and 18:00.

The necessity calculator 16 calculates the necessity based on the obtained stability and necessity model and generates a history data of the necessity in the prediction object period. When the necessity model is a regression formula, the necessity calculator 16 calculates the correction error at N hours later by substituting the obtained stability into the regression formula. The correction error is the necessity to correct the first predicted value at N hours later, that is, at the prediction object day and time.

In step S12, the correction coefficient calculator 9 obtains the correction model generated by the correction model generator 8 in step S4 and obtains the history data of the cloud feature quantity from the cloud feature quantity DB 2. Here, the history data of the cloud feature quantity to be obtained by the correction coefficient calculator 9 is a history data at N hours before a prediction object period.

In step S13, the first predicted value calculator 10 obtains the correction coefficient in the prediction object period calculated by the correction coefficient calculator 9 and obtains the predicted numerical value in the prediction object period from the predicted numerical value DB 4. The first predicted value calculator 10 calculates the first predicted value in the prediction object period based on the obtained correction coefficient and predicted numerical value. According to this, the history data of the first predicted value in the prediction object period is generated. The history data of the first predicted value is stored in the first predicted value DB 5.

In step S14, the second predicted value calculator 17 obtains the history data of the necessity in the prediction object period calculated by the necessity calculator 16 and obtains the history data of the first predicted value in the prediction object period from the first predicted value DB 5. The second predicted value calculator 17 calculates the second predicted value in the prediction object period based on the obtained necessity and first predicted value. Accordingly, a history data of the second predicted value in the prediction object period is generated.

The second predicted value calculated by the second predicted value calculator 17 is stored in the second predicted value DB 12. Also, the second predicted value may be displayed by the display device 103 and may be output to the external device via the communication device 104.

As described above, the weather forecasting apparatus according to the present embodiment can correct the first predicted value based on the stability at N hours before the prediction object day and time. Accordingly, the weather parameter can be predicted with higher accuracy. The reason is as follows.

The weather forecasting apparatus according to the first embodiment corrects the predicted numerical value while assuming that the current weather (at the point of forecasting) is the same as the weather at N hours after that (prediction object day and time). Therefore, when the state of the atmosphere is stable and the weather does not change, the prediction accuracy of the first predicted value becomes higher. Whereas, when the state of the atmosphere is unstable and the weather rapidly changes, the prediction accuracy of the first predicted value becomes lower than that in a case where the state of the atmosphere is stable. Therefore, the correction error which is the error between the first predicted value and the measured value is correlated with the stability which is an index indicating a degree of the stability of the atmosphere.

Accordingly, the prediction accuracy of the weather parameter can be improved by changing a degree of the correction to the first predicted value according to the stability.

The necessity is the correction error at the prediction object day and time in the present embodiment. However, the necessity is not limited to this. For example, the necessity may be a plurality of ranks. In this case, it can be considered that the stability is compared with a threshold and the rank according to the comparison result is set as the necessity. It is preferable that the second predicted value calculator 17 perform predetermined correction according to the rank to the first predicted value.

For example, when the necessity is indicated by two stages, i.e., one or zero, the necessity calculator 16 sets the stability to one when the stability is equal to or more than the threshold and sets the stability to zero when the stability is less than the threshold. The second predicted value calculator 17 does not correct the first predicted value when the necessity is one, and it is preferable that the second predicted value calculator 17 perform the predetermined correction to the first predicted value when the necessity is zero.

Also, the stability may be calculated from the measured value stored in the measured value DB 3 without using the predicted numerical value stored in the predicted numerical value DB 4. In this case, the day and time when the stability has been calculated is a day and time when the measured value used to calculate the stability is measured. When the stability is the weather parameter, which can be measured, such as the strength of the ascending current and the water transpiration from the ground, the stability DB 11 may store the measured value of the weather parameter as the stability. This can be realized by connecting a sensor for measuring the stability to the weather forecasting apparatus via the input device 102 and the communication device 104. Since the stability DB 11 can directly store the measured value of the sensor, it is not necessary to include the stability calculator 13.

In addition, steps S12 and S13 in the present embodiment may be performed following step S6. That is, steps S7 to S11 and S14 may be performed after the first predicted value in the prediction object period has been previously calculated.

### Third Embodiment

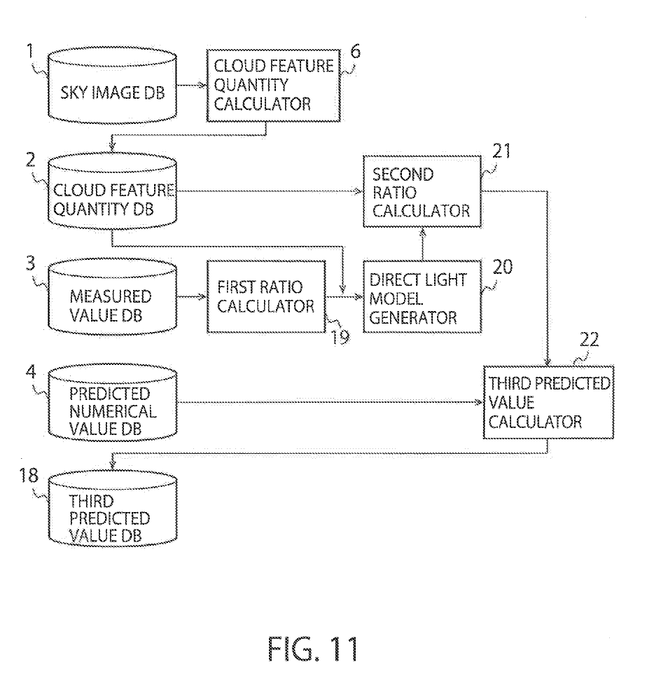

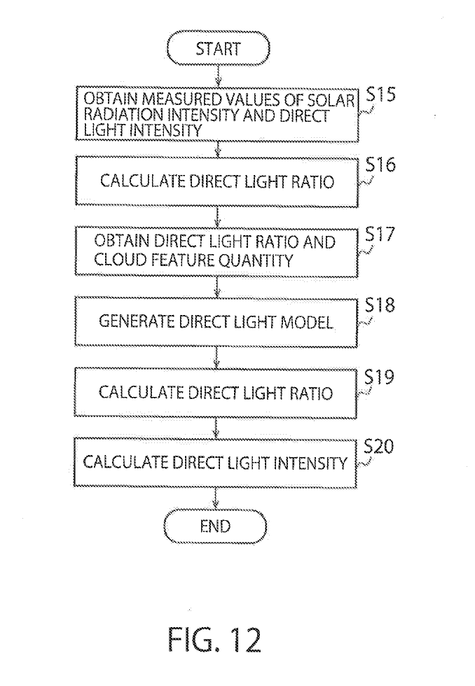

Next, a weather forecasting apparatus according to a third embodiment will be described with reference to FIGS. 11 and 12. The weather forecasting apparatus according to the present embodiment calculates a predicted value of a direct light intensity based on measured values of a solar radiation intensity and the direct light intensity.

First, a function configuration of the weather forecasting apparatus according to the third embodiment will be described with reference to FIG. 11. FIG. 11 is a block diagram of the function configuration of the weather forecasting apparatus according to the present embodiment. As illustrated in FIG. 11, the weather forecasting apparatus includes a sky image DB 1, a cloud feature quantity DB 2, a measured value DB 3, a predicted numerical value DB 4, a third predicted value DB 18, a cloud feature quantity calculator 6, a first ratio calculator 19, a direct light model generator 20, a second ratio calculator 21, and a third predicted value calculator 22.

The sky image DB 1, the cloud feature quantity DB 2, the measured value DB 3, the predicted numerical value DB 4, and the cloud feature quantity calculator 6 are similar to those of the first embodiment. In the present embodiment, the measured value DB 3 stores at least the measured values of the solar radiation intensity and the direct light intensity. Also, the predicted numerical value DB 4 stores at least a predicted numerical value of the solar radiation intensity.

The third predicted value DB 18 stores a third predicted value. The third predicted value is the predicted value of the direct light intensity calculated by the weather forecasting apparatus according to the present embodiment. The direct light intensity is an intensity of the direct light included in solar radiation. The solar radiation includes the direct light and scattering light.

The first ratio calculator 19 calculates a direct light ratio. The direct light ratio is a ratio of the direct light intensity relative to the solar radiation intensity. The first ratio calculator 19 obtains the solar radiation intensity and the direct light intensity of the same day and time from the measured value DB 3 and calculates the direct light ratio. The direct light ratio is calculated by the direct light intensity/the solar radiation intensity.

The direct light model generator 20 (third model generator) generates a direct light model (third model). The direct light model is a model indicating a relation between the cloud feature quantity at a certain day and time and the direct light ratio at N hours (N>0) after the day and time when the cloud feature quantity has been calculated. For example, in a case of N=3, the direct light model indicates a relation between the cloud feature quantity at a certain day and time and the direct light ratio at three hours after that.

The direct light model is generated, for example, by mathematically approximating a correlation between the cloud feature quantity at a certain day and time and the direct light ratio at N hours after that. A linear approximation, a logarithmic approximation, a power approximation, and the like are used as an approximation method. Accordingly, a regression formula having the cloud feature quantity as an explanatory variable and the direct light ratio as an objective variable is generated as the direct light model.

The second ratio calculator 21 calculates the direct light ratio according to the cloud feature quantity. The second ratio calculator 21 obtains the direct light model from the direct light model generator 20 and obtains the cloud feature quantity at N hours before the prediction object day and time from the cloud feature quantity DB 2. When the direct light model is the regression formula, the second ratio calculator 21 calculates the direct light ratio at the prediction object day and time by substituting the cloud feature quantity at N hours before the prediction object day and time into the direct light model.

The third predicted value calculator 22 calculates the third predicted value, that is, the predicted value of the direct light intensity. The third predicted value calculator 22 obtains the predicted numerical value of the solar radiation intensity at the prediction object day and time from the predicted numerical value DB 4 and obtains the direct light ratio at the prediction object day and time from the second ratio calculator 21. The third predicted value calculator 22 calculates the third predicted value at the prediction object day and time by integrating the obtained direct light, ratio to the predicted numerical value of the solar radiation intensity at the prediction object day and time. The third predicted value calculated by the third predicted value calculator 22 is stored in the third predicted value DB 18.

Each function configuration of the weather forecasting apparatus according to the present embodiment is realized by executing the weather forecasting program by the CPU 101. Also, it is preferable that the weather forecasting apparatus according to the present embodiment be connected to a sensor for measuring the solar radiation intensity and the direct light intensity via the input device 102 and the communication device 104.

Next, an operation of the weather forecasting apparatus according to the present embodiment will be described with reference to FIG. 12. FIG. 12 is a flowchart of the operation of the weather forecasting apparatus according to the present embodiment.

First, in step S15, the first ratio calculator 19 obtains history data of the measured values of the solar radiation intensity and the direct light intensity from the measured value DB 3. A period in which the first ratio calculator 19 obtains the history data of the measured values of the solar radiation intensity and the direct light intensity may be previously set and may be specified by a user via the input device 102.

In step S16, the first ratio calculator 19 calculates the direct light ratio based on the obtained measured values of the solar radiation intensity and the direct light intensity and generates a history data of the direct light ratio.

In step S17, the direct light model generator 20 obtains the history data of the direct light ratio calculated by the first ratio calculator 19 and obtains the history data of the cloud feature quantity from the cloud feature quantity DB 2. Here, the history data of the cloud feature quantity to be obtained by the direct light model generator 20 is the history data at N hours before the history data of the direct light ratio. For example, in a case of N=3, the direct light model generator 20 obtains the cloud feature quantity between 7:00 and 12:00 relative to the direct light ratio between 10:00 and 15:00. The kind of the cloud feature quantity obtained by the direct light model generator 20 and the above-mentioned value N may be previously set and may be specified by the user via the input device 102.

In step S18, the direct light model generator 20 generates the direct light model. Here, a linear regression formula which has the direct light ratio as an objective variable and the cloud feature quantity at N hours before the direct light ratio as an explanatory variable is generated as the direct light model. In this case, the regression formula is expressed as Y=AX+B. Y indicates the direct light ratio, and X indicates the cloud feature quantity at N hours before the direct light ratio. A indicates a coefficient (inclination), and B indicates an intercept (direct light ratio in a case where the cloud feature quantity is zero).

In step S19, the second ratio calculator 21 obtains the direct light model generated by the direct light model generator 20 and obtains the history data of the cloud feature quantity from the cloud feature quantity DB 2. Here, the history data of the cloud feature quantity to be obtained by the second ratio calculator 21 is the history data at N hours before the prediction object period. For example, when N=3 is satisfied and the prediction object day and time is between 16:00 and 21:00, the second ratio calculator 21 obtains the history data of the cloud feature quantity between 13:00 and 18:00.

The second ratio calculator 21 calculates the direct light ratio based on the obtained cloud feature quantity and direct light model and generates the history data of the direct light ratio in the prediction object period. When the direct light model is the regression formula, the second ratio calculator 21 calculates the direct light ratio at N hours later by substituting the obtained cloud feature quantity into the regression formula.

In step S20, the third predicted value calculator 22 obtains the direct light ratio in the prediction object period calculated by the second ratio calculator 21 and obtains the predicted numerical value of the solar radiation intensity in the prediction object period from the predicted numerical value DB 4. The third predicted value calculator 22 calculates the direct light intensity (third predicted value) in the prediction object period by integrating the obtained direct light ratio to the predicted numerical value of the solar radiation intensity.

The third predicted value calculated by the third predicted value calculator 22 is stored in the third predicted value DB 18. Also, the third predicted value may be displayed by the display device 103 and output to the external device via the communication device 104.

As described above, the weather forecasting apparatus according to the present embodiment can calculate the predicted value of the direct light intensity based on the cloud feature quantity at N hours before the prediction object day and time. Since the direct light intensity strongly depends on the state of the cloud such as the thickness, shape, kind, and particle size of the cloud, the direct light intensity can be predicted with high accuracy by calculating the direct light ratio by using the cloud feature quantity.

The third predicted value calculator 22 may calculate the third predicted value by using the first predicted value and the second predicted value in which the predicted numerical value of the solar radiation intensity has been corrected. Accordingly, the prediction accuracy of the direct light intensity can be further improved.

Also, the third predicted value calculator 22 may calculate not only the predicted value of the direct light intensity but also that of a scattering light intensity. The predicted value of the scattering light intensity can be calculated by subtracting the predicted value (third predicted value) of the direct light intensity from the predicted numerical value of the solar radiation intensity.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. A weather forecasting apparatus comprising:
a first feature quantity calculator configured to calculate a first feature quantity from a sky image;
a first error calculator configured to calculate a first error between a predicted numerical value which is a predicted value of a weather parameter by a numerical value simulation and a measured value of the weather parameter;
a first model generator configured to generate a first model indicating a relation between the first feature quantity and the first error at a predetermined time after the day and time when the first feature quantity has been calculated;
a first coefficient calculator configured to calculate a first coefficient at a prediction object day and time according to the first feature quantity from the first model and the first feature quantity at the predetermined time before the prediction object day and time; and
a first predicted value calculator configured to calculate a first predicted value of the weather parameter at the prediction object day and time based on the first coefficient at the prediction object day and time and the predicted numerical value of the weather parameter at the prediction object day and time.

2. The apparatus according to claim 1, wherein
the first model is a regression formula indicating a correlation between the first feature quantity and the first error.

3. The apparatus according to claim 1, wherein
the predicted numerical value is a predicted value of the weather parameter calculated by the numerical value simulation.

4. The apparatus according to claim 1, wherein
the first feature quantity is a luminance, a blue component ratio, a luminosity distribution, a color, a thickness of a cloud, a shape of a cloud, or a particle size of a cloud.

5. The apparatus according to claim 1, further comprising:
a second feature quantity calculator configured to calculate a second feature quantity indicating a stability of atmosphere;
a second error calculator configured to calculate a second error between the first predicted value and the measured value;
a second model generator configured to generate a second model indicating a relation between the second feature quantity and the second error at the predetermined time after the day and time when the second feature quantity has been calculated;
a second coefficient calculator configured to calculate a second coefficient at the prediction object day and time according to the second feature quantity from the second model and the second feature quantity at the predetermined time before the prediction object day and time; and
a second predicted value calculator configured to calculate a second predicted value of the weather parameter at the prediction object day and time based on the second coefficient at the prediction object day and time and the first predicted value at the prediction object day and time.

6. The apparatus according to claim 1, wherein
the second feature quantity is calculated based on the predicted numerical value of the weather parameter.

7. The apparatus according to claim 1, wherein
the second feature quantity is the measured value of the weather parameter.

8. A weather forecasting apparatus comprising:
a first feature quantity calculator configured to calculate a first feature quantity from a sky image;
a first ratio calculator configured to calculate a ratio of a direct light intensity included in a solar radiation intensity;
a third model generator configured to generate a third model indicating a relation between the first feature quantity and the ratio at a predetermined time after a day and time when the first feature quantity has been calculated;
a second ratio calculator configured to calculate the ratio at a prediction object day and time according to the first feature quantity from the third model and the first feature quantity at the predetermined time before the prediction object day and time; and
a third predicted value calculator configured to calculate the direct light intensity at the prediction object day and time based on the first coefficient at the prediction object day and time and the predicted numerical value of the solar radiation intensity at the prediction object day and time.

9. A weather forecasting method comprising:
calculating a first feature quantity from a sky image;
calculating a first error between a predicted numerical value which is a predicted value of a weather parameter by a numerical value simulation and a measured value of the weather parameter;
generating a first model indicating a relation between the first feature quantity and the first error at a predetermined time after a day and time when the first feature quantity has been calculated;
calculating a first coefficient at a prediction object day and time according to the first feature quantity from the first model and the first feature quantity at the predetermined time before the prediction object day and time; and
calculating a first predicted value of the weather parameter at the prediction object day and time based on the first coefficient at the prediction object day and time and the predicted numerical value at the prediction object day and time.
